(19) United States
(12) Patent Application Publication
(10) Pub. No.: US 2026/0225671 A1
(43) Pub. Date: Aug. 6, 2026

(54) Autonomous Mobile Robot with Increased Payload Capacity

(71) Applicant: Skild-Fetch LLC, Pittsburgh, PA (US)

(72) Inventors: Vincent C. Cheung, San Jose, CA (US); Cory D. Lent, Campbell, CA (US); Charles Pitzer, San Jose, CA (US)

(21) Appl. No.: 19/343,728

(22) Filed: Sep. 29, 2025

Related U.S. Application Data
(60) Provisional application No. 63/752,576, filed on Jan. 31, 2025.

(51) Int. Cl. B62D 37/04; B60G 17/00; B60K 1/00

(52) U.S. Cl. CPC B62D 37/04; B60G 17/00; B60K 1/00

(57) ABSTRACT

The present disclosure is directed to a ballast for an autonomous mobile robot. The mobile robot can include a frame, a top plate coupled to an upper surface of the frame and configured to support a payload, one or more support wheels coupled to a lower surface of the frame and configured to support the payload through the frame, a drive assembly including a drive wheel configured to engage a surface upon which the mobile robot travels, and a ballast coupled to the drive assembly. The drive assembly is movably coupled to the frame, and the ballast is positioned to impart a downward force on the drive wheel. The ballast is configured to maximize the downward force on the drive wheel, independent of the payload supported by the frame, thereby maximizing traction of the drive wheel.

### RELATED APPLICATIONS

This application claims the benefit of U.S. Provisional Application No. 63/752,576, filed January 31, 2025, which is incorporated by reference herein in its entirety.

### BACKGROUND

Transferring a downward force provided by a payload of an autonomous mobile robot to a locomotive system (e.g., drive wheels) of the autonomous mobile robot can present challenges, particularly where the robot utilizes caster wheels or other structures that serve a primary function of supporting the payload, and where the locomotive system functions primarily to provide a motive force to the mobile robot for transportation of the payload (e.g., does not function to support the payload). Particularly, the locomotive system of the mobile robot must be provided with a sufficient downward force to generate the necessary traction for transporting a given payload. Existing mobile robots may be configured to support a payload directly (e.g., primarily through a frame and caster wheels of the mobile robot), or may be configured to support the payload indirectly by engaging a mobile support structure (e.g., a cart, shelves, and the like) that supports the payload. Furthermore, some mobile robots may be configured to transport and/or support both direct and indirect payloads.

Because the locomotive system of a mobile robot may not directly support the payload, there may be insufficient downward force on drive wheels of the locomotive system to provide the necessary traction (e.g., between the drive wheels and a surface of a facility) to move the robot in a desired manner when it is transporting a payload. To provide additional downward force to the locomotive system, and thereby increase traction and/or stability, some mobile robots are provided with ballast weight. However, because the ballast weight of existing mobile robots is ultimately supported by the caster wheels and/or frame and is not transferred to the locomotive system, much of the benefit of the additional downward force (e.g., traction) is lost.

Some mobile robots are provided with preloaded springs, or shocks, between the frame and the locomotive system to increase the downward force on the locomotive system. However, this approach also presents challenges. For example, the downward force provided by the springs is limited by the weight of the mobile robot. As such, achieving a sufficient downward force on the locomotive system may require a higher spring shock preload and the corresponding addition of extra ballast to the robot. While additional spring preload and ballast may partially address the issue of downward force provided to the locomotive system, there are drawbacks to this approach. For example, increasing the preload in the spring shocks can cause instability in the robot and lead to undesirable behaviors such as "porpoising," where the nose of the mobile robot bobs, undesirably, downwards and upwards during decelerations and accelerations, respectively.

Furthermore, the addition of extra ballast to the robot may cause motors of the locomotive system to draw power at a faster rate from a depletable power source (e.g., a rechargeable battery), thereby reduced runtimes of the mobile robot. Further still, selecting an appropriate spring preload, and tuning a suspension assembly of the mobile robot, can be challenging due to the variable nature of the load placed on the spring. For example, one spring preload may be appropriate for the mobile robot when it is not carrying a payload, another spring preload may be appropriate when the robot is supporting its maximum payload, and yet another spring preload may be appropriate where the robot is engaged with a mobile support structure. More importantly, the load path of additional ballast provided on the robot may not necessarily travel through the drive wheels. For example, where the additional ballast is affixed to a frame of the robot, much of the downforce provided by the ballast travels through the aforementioned caster wheels and may not increase the load on the wheels. Similarly, where the robot is engaged with a support structure and/or payload, much of the downforce provided by the support structure and/or payload travels through the caster wheels and may not increase the load on the wheels.

The present disclosure addresses the foregoing and other issues associated with currently available autonomous mobile robots.

### SUMMARY

The present disclosure is directed to a mobile robot including a frame having an upper surface and a lower surface, a top plate coupled to the upper surface of the frame and configured to support a payload, one or more support wheels coupled to the lower surface of the frame and configured to support the payload through the frame, a drive assembly including a drive wheel configured to engage a surface upon which the mobile robot travels, and a ballast coupled to the drive assembly, which is ballast positioned to impart a downward force on the drive wheel. The drive assembly is movably coupled to the frame, and the ballast is configured to maximize the downward force on the drive wheel, independent of the payload supported by the frame, thereby maximizing traction of the drive wheel.

According to some aspects of the present disclosure, the mobile robot can include a mounting plate configured to couple the ballast to the drive assembly. The drive assembly can include a drive axle extending along a rotational axis of the drive wheel, where the drive axle extends through an aperture in the mounting plate, thereby coupling the drive assembly to the mounting plate and providing for rotational movement therebetween. A center of mass of the ballast can be substantially vertically aligned with the rotational axis of the drive wheel and the ballast can be rigidly coupled to the mounting plate.

According to additional aspects of the present disclosure, the mobile robot can include a sliding assembly configured to couple the drive assembly to the frame. The sliding assembly can include a first sliding member coupled to the frame and a second sliding member coupled to the mounting plate. The sliding assembly can be configured to permit vertical linear movement of the drive assembly relative to the frame and restrict lateral movement of the drive assembly relative to the frame.

According to further aspects of the present disclosure, the mobile robot can include a suspension assembly configured to bias the drive assembly away from the frame, thereby pressing the drive wheel into a floor or other support surface. A first suspension member of the suspension assembly can be coupled to the frame and a second suspension member of the suspension assembly can be coupled to the mounting plate. A spring member can be positioned to bias the first suspension member away from the second suspension member, thereby biasing the drive assembly away from the frame.

According to further aspects of the present disclosure, the ballast can be formed of a high-density material, and the ballast can be positioned such that the ballast does not impart a downward force on the support wheel of the mobile robot. The ballast can also be positioned within an internal cavity of the mobile robot defined by one or more of the frame, the drive wheel, and a housing of the mobile robot. According to some examples, the ballast is sized and shaped to maximize a volume of the internal cavity occupied by the ballast. According to further examples, the ballast comprises a curved lower surface configured to follow an engagement surface of the drive wheel.

According to still further aspects of the present disclosure, the mobile robot can include a second drive assembly with a second drive wheel configured to engage the surface upon which the mobile robot travels, and a second ballast coupled to the second drive assembly, with the second ballast being positioned to impart a second downward force on the second drive wheel. According to one example, the second drive assembly is movably coupled to the frame. According to further examples, each of the drive assemblies are independently movable relative to the frame and to each other.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a top perspective view of an autonomous mobile robot according to embodiments of the present disclosure;

FIG. 2 is a top perspective view of the autonomous mobile robot of FIG. 1 with an exterior housing removed therefrom;

FIG. 3 is a top perspective view of the autonomous mobile robot of FIG. 1 illustrating a frame and locomotive system thereof according to embodiments of the present disclosure;

FIG. 4 is a top perspective view of the autonomous mobile robot of FIG. 1 illustrating a suspension assembly thereof according to embodiments of the present disclosure;

FIG. 5 is a bottom perspective view of the autonomous mobile robot of FIG. 1 illustrating the suspension assembly thereof according to embodiments of the present disclosure; and

FIG. 6 is a side elevational view of the autonomous mobile robot of FIG. 1 illustrating the suspension assembly thereof according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

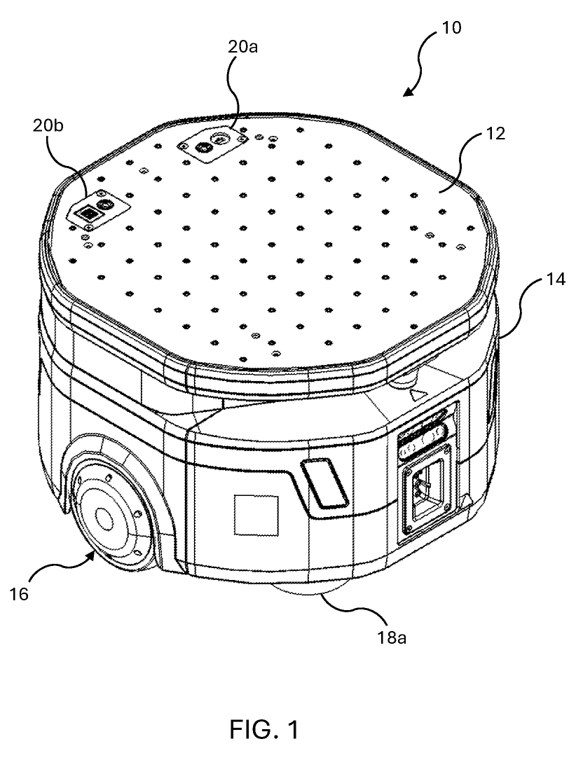

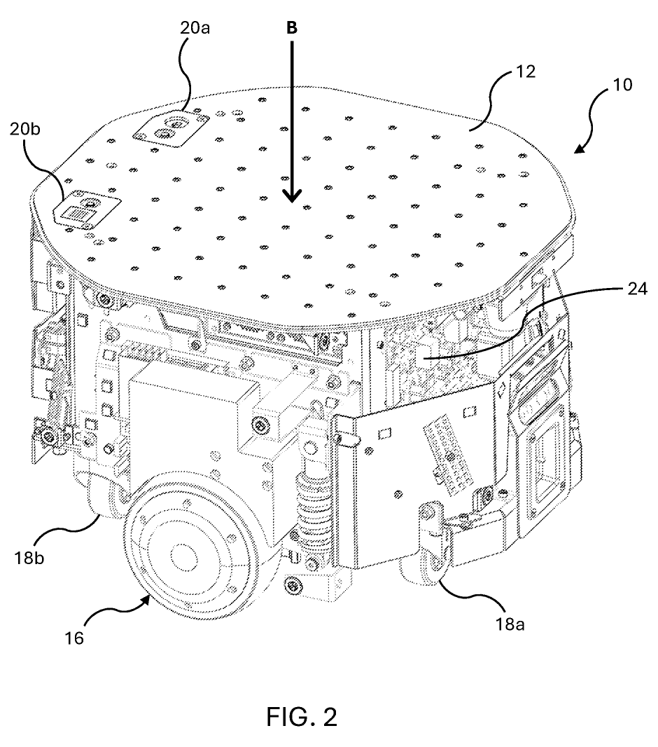

FIG. 1 is a top perspective view of an autonomous mobile robot (hereinafter, “robot 10”), and FIG. 2 is a top perspective view of the robot 10 illustrating internal components thereof, according to embodiments of the present disclosure. FIGS. 1-2 are referred to jointly herein.

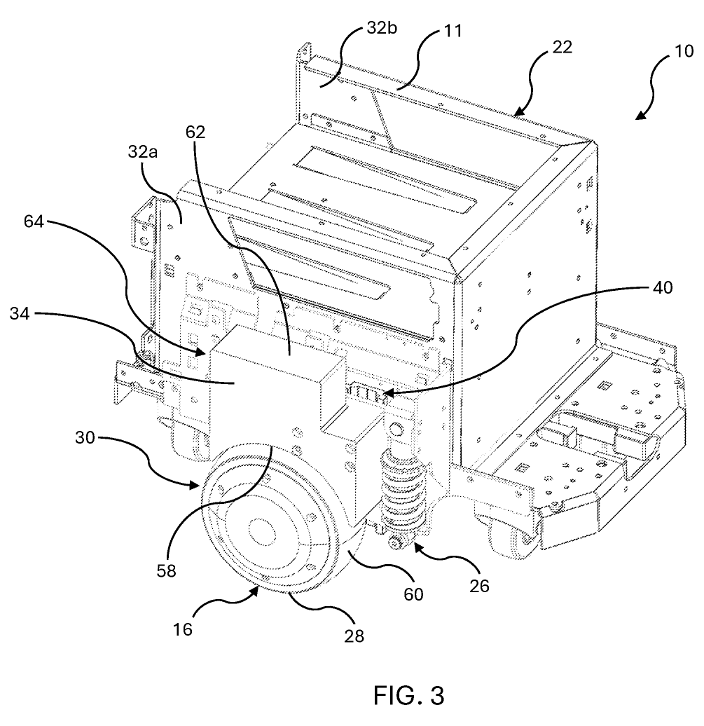

As shown, the robot 10 includes a top plate 12, a housing 14, a locomotive system 16, and caster wheels 18a-d (together, “caster wheels 18”). The top plate 12 is attached to a top surface 11 of a frame 22 (see, e.g., FIG. 3) and the caster wheels 18 are attached to a lower surface 13 of the frame 22. The top plate 12 can be configured to receive a payload and/or one or more accessories (not shown), such as for example, an apparatus for engaging a mobile support structure (e.g., a cart, shelves, etc.), which can be powered and/or controlled via auxiliary ports 20a-b. It should be understood that a downward force imparted on the top plate 12 by a payload disposed thereon is transferred through the frame 22 and the caster wheels 18 to a floor or other surface upon which the robot 10 is supported. The housing 14 can be affixed about the frame 22 of the robot 10 and is configured to isolate and/or protect internal components 24 (e.g., one or more controllers, sensors, power systems, navigation systems, etc.) from an external environment of the robot 10. Of course, those of ordinary skill in the art will be familiar with a plurality of internal components 24, required for the operation and control of an autonomous mobile robot and, as such, an exhaustive discussion of said components is not included in the present disclosure.

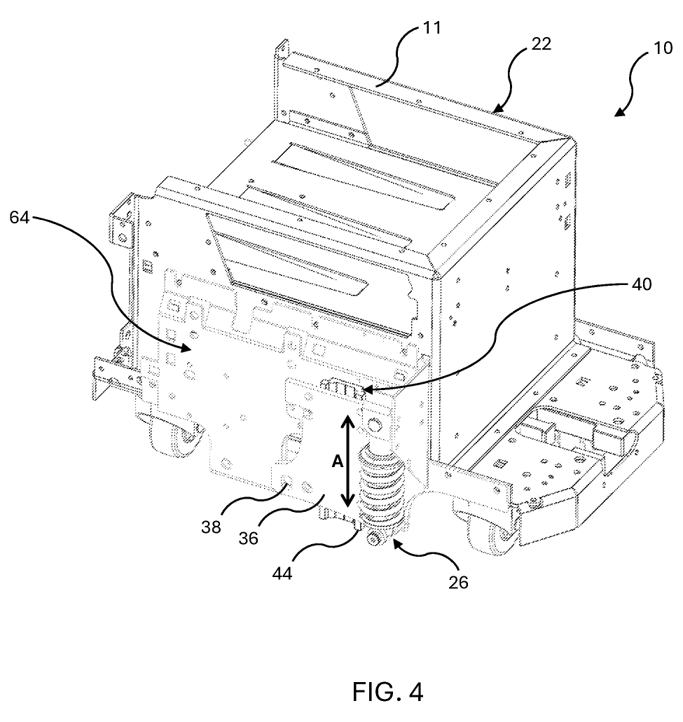

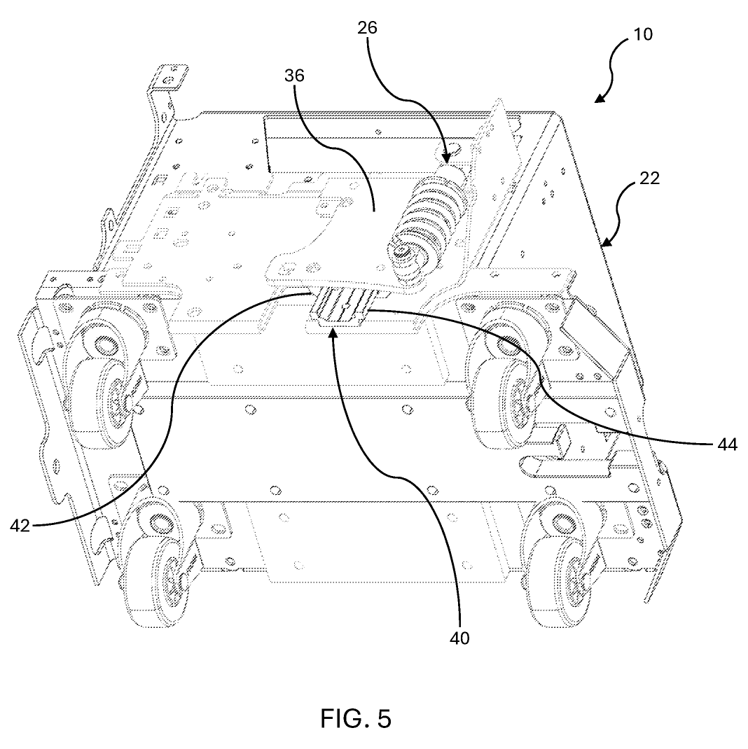

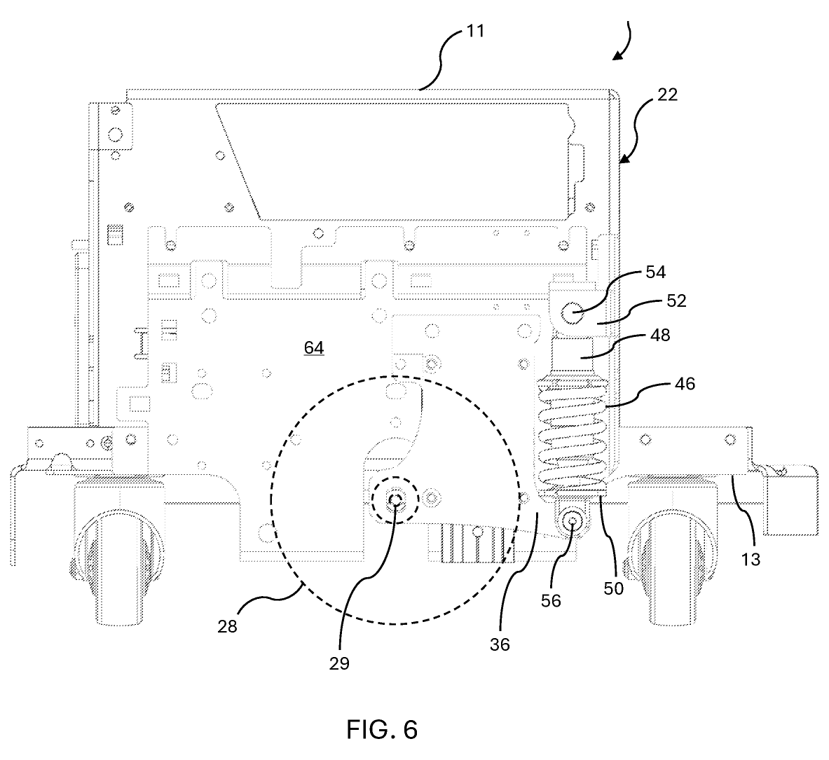

FIGS. 3-6 illustrate exemplary configurations of the locomotive system 16 and a suspension assembly 26 of the robot 10 according to embodiments of the present disclosure and are referred to jointly herein. Specifically, FIG. 3 is a top perspective view of the robot 10, showing the frame 22 and locomotive system 16 thereof, with internal components 24 removed for clarity, and FIGS. 4-5 are perspective views and FIG. 6 is a side elevational view of the robot 10, further illustrating the suspension assembly 26 thereof, with the locomotive system 16 removed for clarity.

According to embodiments of the present disclosure, the locomotive system 16 includes first and second drive assemblies 30, each being slidably coupled to opposing sides 32a-b of the frame 22 of the robot 10, thereby providing for an independent suspension configuration between each of the drive assemblies 30 and the frame 22.

Each of the drive assemblies 30 can include a drive wheel 28, a motor (not shown) configured to provide motive force to the drive wheel 28, a drive shaft 29 (see FIG. 6) coupling the motor to the drive wheel 28, a ballast weight 34 (hereinafter “ballast 34”) configured to maximize a downward force on the drive wheel 28, and a mounting plate 36. The drive shaft 29 is disposed through an aperture 38 in the mounting plate 36 and is rotatably affixed thereto (e.g., by way of bearings, bushings, etc.), thereby securing the drive wheel 28 to the mounting plate 36. Additionally, the ballast 34 is rigidly coupled to the mounting plate 36 (e.g., by way of one or more bolts, or other fixation devices). Accordingly, a downward force provided by the ballast 34 is transferred through the mounting plate 36 and the drive shaft 29 to the drive wheel 28, thereby providing the drive wheel 28 with additional downward force and traction. According to some embodiments of the present disclosure, one or more of the drive wheel 28, the drive shaft 29, and the motor of the drive assembly 30 can be incorporated into a wheel hub motor, or similar device, having a motor incorporated into a hub of the wheel. According to such embodiments, the wheel hub motor can be rigidly affixed to the mounting plate 36, since the degree-of-freedom and motor are inside the hub wheel. Those of ordinary skill in the art will understand that additional technologies and/or configurations of the drive assemblies 30 can be utilized to facilitate movement of the robot 10 throughout its environment, without departing from the spirit and scope of the present disclosure.

Each drive assembly 30 is slidably coupled to the frame 22 by way of a linear sliding assembly 40, including a first sliding member 42 (see FIG. 5) rigidly coupled to the mounting plate 36 (e.g., by way of one or more bolts, or other fixation devices) and a second sliding member 44 rigidly coupled to the frame 22 (e.g., by way of one or more bolts, or other fixation devices). Accordingly, each drive assembly 30 can be translated relative to the frame 22 in a vertical linear direction, as shown by Arrow A of FIG. 4, but is restrained from movement in other directions and/or axes. Those of ordinary skill in the art will understand that other means for providing relative movement between the drive assembly 30 and the frame 22 can be utilized without departing from the spirit and scope of the present disclosure.

The suspension assembly 26 is coupled between the drive assembly 30 and the frame 22 of the robot 10 and includes a spring 46 compressed between a strut 48 and a shaft 50. As shown, the strut 48 is attached to the frame 22 by way of a bracket 52 and a pin 54 extending therethrough, and the shaft 50 is attached to the mounting plate 36 of the drive assembly 30 by way of a pin 56. The spring 46 is configured to bias the drive assembly 30 away from the frame 22, thereby pressing the drive wheel 28 against the floor of the facility.

As discussed hereinabove, the drive assemblies 30 are independently movable relative to the frame 22 of the robot 10, thereby providing for an independent suspension configuration between each of the drive assemblies 30 and the frame 22. However, according to other embodiments of the present disclosure, the locomotive system 16 could comprise a drive assembly wherein the drive wheels 28 rotate about a single shared axis and move together relative to the frame 22 (e.g., a solid axle suspension). Those of skill in the art will understand that additional suspension configurations can also be utilized to provide for movement of the drive wheels 28 relative to the frame 22 without departing from the spirit and scope of the present disclosure.

Notably, during operation of the robot 10, a downward force from a payload positioned on or over the top plate 12, illustrated by Arrow B of FIG. 2, is transferred to the caster wheels 18 via the frame 22. As such, the payload does not directly impart a downward force on the drive wheels 28 and, therefore, does not directly bolster the traction of the robot 10. As those of skill in the art will understand, generally, the total downward force acting on the drive wheel 28 is the sum of the force provided by the spring 46 and the load provided by the drive assembly 30 (e.g., unsprung mass of the robot 10). Furthermore, friction between the drive wheel 28 and the floor of the facility increases as the total downward force (e.g., the normal force) acting on the drive wheel 28 increases, as does traction. Therefore, to maximize traction and thus payload capacity of the robot 10, the total downward force acting on the drive wheel 28 must be maximized. However, as discussed herein, increasing the total downward force in the drive wheel 28 by increasing the force provided by the spring 46 (e.g., preload) is limited and can negatively impact operation of the robot 10. As such, embodiments of the present disclosure maximize the total downward force on the drive wheel 28 by maximizing the load imparted on the drive assembly 30 by way of ballast 34.

As discussed above, ballast 34 is rigidly coupled to mounting plate 36 (e.g., by way of one or more bolts, or other fixation devices) of drive assembly 30, and the load provided by ballast 34 is transferred through the mounting plate 36 and the drive shaft 29 to the drive wheel 28, thereby providing the drive wheel 28 with additional downward force and traction.

With returning reference to FIGS. 2-3, ballast 34 can be positioned above the drive wheel 28, such that a center of mass of ballast 34 is closely aligned with a center of drive wheel 28 (e.g., along the axle), thereby maximizing the downward force from ballast 34 acting on drive wheel 28. Stated differently, coupling the ballast 34 to the drive assembly 30 allows for the downward force from the ballast 34 to directly load the drive wheel 28 of the robot 10 (without going through the suspension assembly or wasting downward force through the caster wheels).

The size, shape, and/or material of ballast 34 can also be configured to maximize the load (e.g., weight) on drive wheel 28. As shown, ballast 34 occupies an internal cavity 64 defined by one or more of the top plate 12, housing 14, frame 22, internal components 24, and drive wheel 28 of the robot 10, and the ballast 34 can be sized and shaped to fill a maximum volume of internal cavity 64. For example, ballast 34 can have a width approximately equal to drive wheel 28, a bottom surface 58 having a curvature designed to follow (e.g., skirt) an engagement surface 60 of drive wheel 28, and a top surface 62 extending towards the top plate 12. Notably, top surface 62 may not fully extend to top plate 12 to allow for movement of drive assembly 30 relative to frame 22 and corresponding linear travel of suspension assembly 26. Additionally, the ballast 34 can be formed from a material selected to maximize the weight of the ballast 34, such as, for example, steel, lead, or other materials having a relatively high mass per unit volume (e.g., density)

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. The term “may” is defined as equivalent to the term “can”.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A mobile robot, comprising:
a frame having an upper surface and a lower surface;
a top plate coupled to the upper surface of the frame and configured to support a payload;
one or more support wheels coupled to the lower surface of the frame and configured to support the payload through the frame;
a drive assembly including a drive wheel configured to engage a surface upon which the mobile robot travels; and
a ballast coupled to the drive assembly, the ballast positioned to impart a downward force on the drive wheel;
wherein the drive assembly is movably coupled to the frame; and
wherein the ballast is configured to maximize the downward force on the drive wheel independent of the payload supported by the frame, thereby maximizing traction of the drive wheel.

2. The mobile robot of claim 1, comprising a mounting plate configured to couple the ballast to the drive assembly.

3. The mobile robot of claim 2, wherein the drive assembly includes a drive axle extending along a rotational axis of the drive wheel, and wherein the drive axle extends through an aperture in the mounting plate, thereby coupling the drive assembly to the mounting plate and providing for rotational movement therebetween.

4. The mobile robot of claim 3, wherein a center of mass of the ballast is substantially vertically aligned with the rotational axis of the drive wheel.

5. The mobile robot of claim 2, wherein the ballast is rigidly coupled to the mounting plate.

6. The mobile robot of claim 2, comprising a sliding assembly configured to couple the drive assembly to the frame.

7. The mobile robot of claim 6, wherein the sliding assembly comprises a first sliding member coupled to the frame and a second sliding member coupled to the mounting plate.

8. The mobile robot of claim 6, wherein the sliding assembly is configured to permit vertical linear movement of the drive assembly relative to the frame and restrict lateral movement of the drive assembly relative to the frame.

9. The mobile robot of claim 2, comprising a suspension assembly configured to bias the drive assembly away from the frame, thereby pressing the drive wheel into a floor or other support surface.

10. The mobile robot of claim 9, wherein a first suspension member of the suspension assembly is coupled to the frame and a second suspension member of the suspension assembly is coupled to the mounting plate.

11. The mobile robot of claim 10, wherein the suspension assembly comprises a spring member positioned to bias the first suspension member away from the second suspension member, thereby biasing the drive assembly away from the frame.

12. The mobile robot of claim 1, wherein the ballast is positioned such that the ballast does not impart a downward force on the support wheel.

13. The mobile robot of claim 1, wherein the ballast is formed of a high-density material.

14. The mobile robot of claim 1, wherein the ballast is positioned within an internal cavity defined by one or more of the frame, the drive wheel, and a housing of the mobile robot.

15. The mobile robot of claim 14, wherein the ballast is sized and shaped to maximize a volume of the internal cavity occupied by the ballast.

16. The mobile robot of claim 15, wherein the ballast comprises a curved lower surface configured to follow an engagement surface of the drive wheel.

17. The mobile robot of claim 1, comprising:
a second drive assembly including a second drive wheel configured to engage the surface upon which the mobile robot travels; and
a second ballast coupled to the second drive assembly, the second ballast positioned to impart a second downward force on the second drive wheel;
wherein the second drive assembly is movably coupled to the frame.

18. The mobile robot of claim 17, wherein each of the drive assemblies are independently movable relative to the frame and to each other.
